(19) United States
(12) Patent Application Publication
(10) Pub. No.: US 2024/0139917 A1
(43) Pub. Date: May 2, 2024

(54) OPERATION-FREE CONNECTION STRUCTURE

(71) Applicant: Tsung-Te LIN, Taichung City (TW)

(72) Inventor: Tsung-Te LIN, Taichung City (TW)

(21) Appl. No.: 18/486,301

(22) Filed: Oct. 13, 2023

(30) Foreign Application Priority Data
Oct. 28, 2022 (TW) 111141119

(51) Int. Cl. B25B 23/00; B25B 13/46; B25B 15/02

(52) U.S. Cl. CPC B25B 23/0035; B25B 13/461; B25B 15/02

(57) ABSTRACT

An operation-free connection structure includes a main bar, a detent lever, a steel ball, a spring, and an operating member. Within the main bar, an elongated chamber is formed, featuring an elongated first hole and a second hole communicating with the chamber. Within the chamber, the detent lever is positioned and is recessed with a first groove and a second groove, with the first groove having a smaller depth than the second groove. The steel ball is located in the first hole and a spring exerts pressure on both the detent lever and the steel ball. This arrangement allows a portion of the steel ball to be embedded in the first groove while another portion protrudes outwardly from the main bar, and the steel ball can then be compressed and rolled into the second groove, thereby freeing the operation of the operating member from connection to an operating tool.

### CROSS-REFERENCE TO RELATED U.S. APPLICATIONS

Not applicable.

### BACKGROUND OF THE INVENTION

### 1. Field of the Invention

The present invention relates to a tool for connecting a driven tool; in particular, it relates to an operation-free connection structure.

### 2. Description of Related Art Including Information Disclosed Under 37 CFR 1.97 and 37 CFR 1.98

A socket is a rotary-driven tool used for tightening or loosening fasteners such as bolts or nuts. In some circumstances where it is difficult to reach the locations of the bolt or nut with the socket, a long extension connecting tool can be used to connect the socket, allowing the user to drive and rotate the socket remotely.

The connecting tool comprises an elongated main bar, a detent lever, an operating member, a spring, and a steel ball, wherein one end of the main bar is used for connecting an operating tool (e.g., a ratchet wrench) and the other end is used for inserting into the socket. A chamber is formed inside the main bar, which is radially formed with a first setting hole and a second setting hole communicating with the chamber, respectively. The detent lever is provided in the chamber, and the operating member is provided in the second setting hole and abutted against the detent lever; the detent lever threads the spring with both ends thereof pressing against the main bar and the detent lever, respectively, thereby allowing the detent lever to move reciprocally along the axial direction relative to the main bar. The first setting hole is embedded with the steel ball, in which a portion of it abuts against the detent lever while another portion protrudes outwardly from the radial direction of the main bar.

When the connecting tool is connected to the socket, the operating member is pressed toward the inner direction of the main bar to drive the steel ball into the main bar while the main bar is inserted into a drive hole of the socket. When the pressure applied to the operating member is released, the detent lever exerts a force on the steel ball to press it against the inner wall of the drive hole. This further insertion of the main bar into the drive hole continues until the steel ball aligns with a recess in the drive hole, allowing it to be securely embedded in the recess and completing the process of connecting the connecting tool to the socket.

In the process of connecting the connecting tool to the socket, the operating member is depressed, which in turn initiates the axial movement of the detent lever. This action allows the socket to apply pressure to the steel ball, facilitating its further entry into the main bar, allowing the steel ball to enter the socket and subsequently be embedded in the recess, completing the connection between the connecting tool and the socket. While effective, this connection process can be considered complex due to its operational complexity.

Taiwan Patent Certificate No. TWM412037 discloses a socket device that can be used to connect a tool to a socket.

### BRIEF SUMMARY OF THE INVENTION

The main purpose of the present invention is to provide an operation-free connection structure.

In order to achieve the above purpose, the present invention employs the following technical solutions.

An operation-free connection structure, which is used to connect a driven tool having a polygonal drive hole in which a recessed recess is formed on a wall within the drive hole; the connection structure comprises an elongated main bar, one axial end of the main bar being defined as a first end, a coupling drive being provided on the main bar in conjunction with the drive hole extending to the first end such that the coupling drive is axially inserted into the drive hole to rotate the driven tool. The main bar is axially formed with an elongated chamber therein extending to the first end, and the main bar is axially formed with a first hole and a second hole both connected to the chamber and to a radial periphery of the main bar, respectively, the first hole being located between the second hole and the first end, the first hole being formed in the coupling drive.

A detent lever is provided in the chamber. The radial periphery of the detent lever is recessed with a first groove and a second groove. The depth of the first groove is smaller than the depth of the second groove along the radial direction of the detent lever. The first groove is located between the first end and the second groove, and the first groove and the second groove are configured along the axial direction of the detent lever.

A steel ball is disposed in the first hole.

A spring is provided. The detent lever axially threads the spring, and both ends of the spring press against the detent lever and the steel ball, respectively, so that a portion of the steel ball is embedded in the first groove and the other portion thereof protrudes outwardly from the radial surface of the main bar

An operating member is provided in the second hole, wherein a portion of the operating member protrudes radially outwardly from the main bar and another portion thereof enters into the inner portion of the main bar and abuts against the detent lever, thereby enabling the operating member to force the detent lever to be axially displaced toward the first end.

Wherein, the first hole is an elongated hole, the length of the first hole along the axial direction of the main bar is greater than the width of the first hole along the lateral direction of the coupling drive, and the width of the first hole along the lateral direction of the coupling drive is smaller than the outer diameter of the steel ball, which allows the steel ball to be compressed by the driven tool to roll and embed in the second groove, thereby facilitating the free operation of the operating member to accomplish the operation of connecting the coupling drive with the driven tool.

The primary effect and advantage of the present invention lies in the seamless connection and positioning of the coupling drive and the driven tool, which is accomplished without the need for manual pressing or operation of the operating member. This feature greatly simplifies the connection process and increases the overall ease of operation.

### BRIEF DESCRIPTION OF THE SEVERAL VIEWS OF THE DRAWINGS

FIG. 1 is a three-dimensional diagram of the Embodiment 1 of the present invention.

FIG. 2 is a three-dimensional exploded diagram of the Embodiment 1 of the present invention.

FIG. 3 is a schematic cross-sectional diagram of the main bar of Embodiment 1 of the present invention.

FIG. 4 is a partial cross-sectional diagram of the Embodiment 1 of the present invention.

FIG. 5 is a line 5-5 cross-sectional diagram of FIG. 4.

FIG. 6 is a partial cross-sectional diagram of the driven tool in connection with Embodiment 1 of the present invention in a state of operation.

FIG. 7 is a partial cross-sectional diagram of the driven tool in connection with Embodiment 1 of the present invention in a state of use.

FIG. 8 is a three-dimensional diagram of the Embodiment 2 of the present invention.

FIG. 9 is a schematic cross-sectional diagram of a part of Embodiment 2 of the present invention in a state of use.

FIG. 10 is a three-dimensional diagram of Embodiment 3 of the present invention.

FIG. 11 is a partial cross-sectional diagram of Embodiment 4 of the present invention.

### DETAILED DESCRIPTION OF THE INVENTION

While reference is made to the drawings depicting embodiments of an operation-free connection structure of the present invention, it is important to note that these embodiments are provided solely for illustrative purposes and do not impose limitations on the scope of this structure as defined in the patent application.

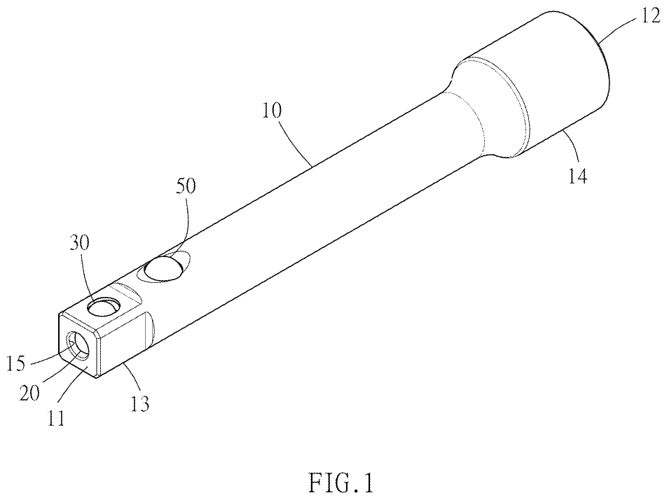

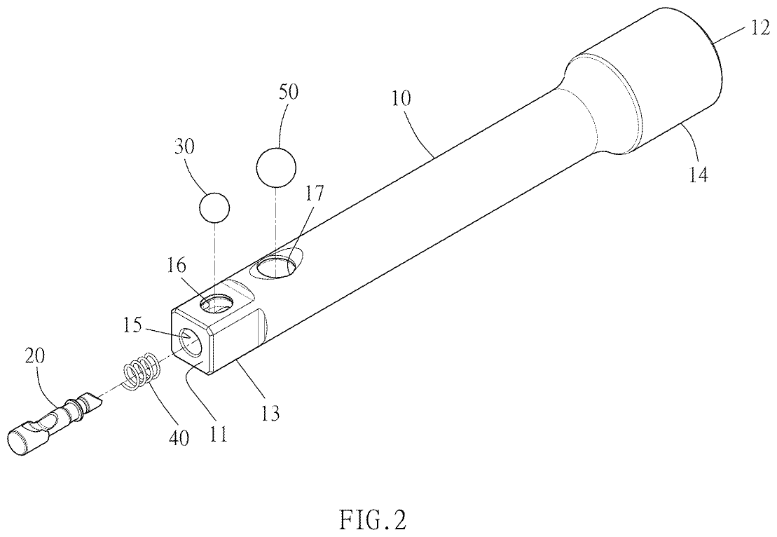

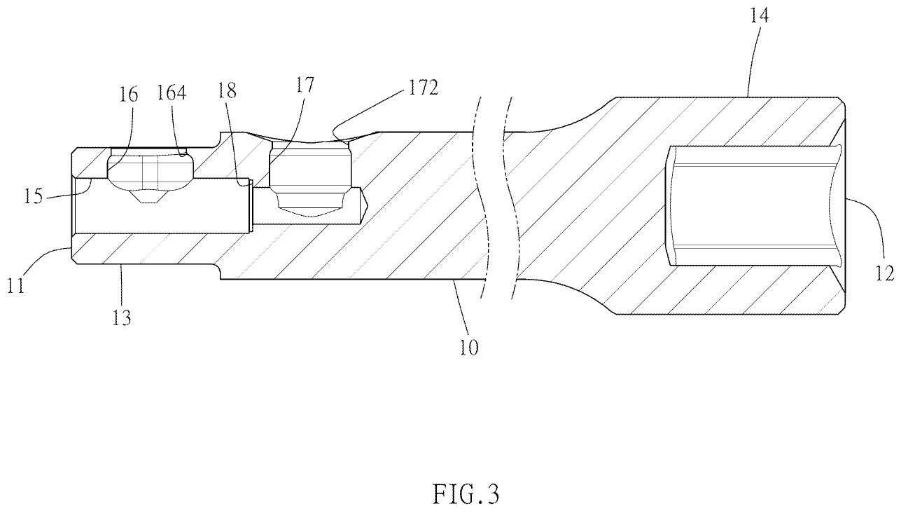

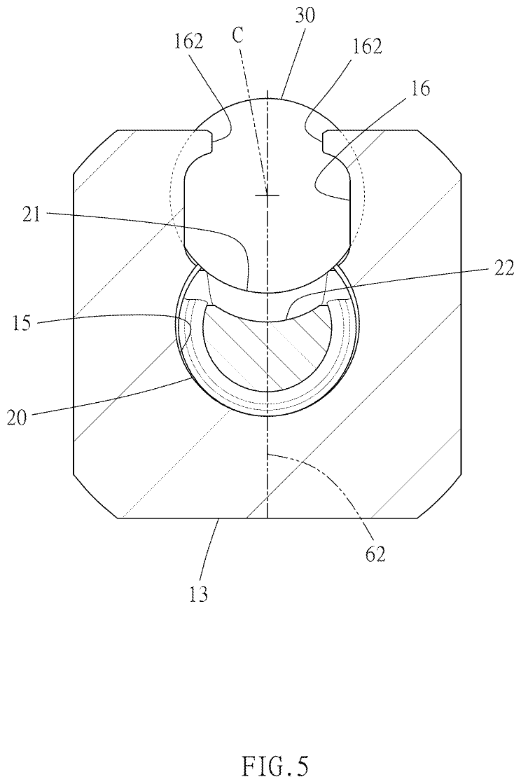

As shown in FIGS. 1 to 7, which show an Embodiment 1 of the operation-free connection structure for connecting a driven tool 91 and an operating tool (not shown), the operating tool is a ratchet wrench having a polygonal drive end which allows the operating tool to drive the driven tool 91 to rotate by means of the Embodiment 1. One end of the driven tool 91 is formed into a polygonal drive hole 92 in which a recessed recess 93 is formed on a wall within the drive hole 92, and the driven tool 91 may be a socket or a tool of other shape which can be operated by force.

The Embodiment 1 comprises an elongated main bar 10, a detent lever 20, a steel ball 30, a spring 40, and an operating member 50, wherein one axial end of the main bar 10 is defined as a first end 11 and the other end is defined as a second end 12. A coupling drive 13 is provided on the main bar 10 in conjunction with that drive hole 92, and the coupling drive extends to the first end 11, allowing the coupling drive 13 to be axially inserted into the drive hole 92 to rotate the driven tool 91. The main bar 10 for fitting over the drive end of the operating tool is formed into a connection portion 14 extending to the second end 12 and being a polygonal drive hole that fits over the drive end, thereby allowing the connection portion 14 to be connected to the operating tool. The operating tool drives the driven tool 91 to rotate by means of the main bar 10 having an elongated chamber 15 formed axially therein, and the chamber 15 extends to the first end 11. The main bar 10 is axially formed with a first hole 16 and a second hole 17 both connected to the chamber 15 and to a radial periphery of the main bar 10, respectively, the first hole 16 being located between the second hole 17 and the first end 11, the first hole 16 being formed in the coupling drive 13, and the steel ball 30 being disposed in the first hole 16.

The detent lever 20 is provided in the chamber 15, and the radial periphery of the detent lever 20 is recessed with a first groove 21 and a second groove 22. The depth of the first groove 21 is smaller than the depth of the second groove 22 along the radial direction of the detent lever 20. The first groove 21 is located between the first end 11 and the second groove 22, and the first groove 21 and the second groove 22 are configured along the axial direction of the detent lever 20 which is axially threaded with the spring 40.

Both ends of the spring 40 press against the detent lever 20 and the steel ball 30, respectively, so that a portion of the steel ball 30 can be embedded in the first groove 21 and the other portion thereof protrudes outwardly from the radial surface of the main bar 10.

The operating member 50 is provided in the second hole 17, wherein a portion of the operating member 50 protrudes radially outwardly from the main bar 10 and another portion thereof enters into the inner portion of the main bar 10 and abuts against the detent lever 20, thereby enabling the operating member 50 to force the detent lever 20 to be axially displaced toward the first end 11.

The first hole 16 is an elongated hole, the length of the first hole 16 along the axial direction of the main bar 10 is greater than the width of the first hole 16 along the lateral direction of the coupling drive 13, and the width of the first hole 16 along the lateral direction of the coupling drive 13 is smaller than the outer diameter of the steel ball 30, which allows the steel ball 30 to be compressed by the driven tool 91 to roll and embed in the second groove 22, thereby facilitating the free operation of the operating member 50 to accomplish the operation of connecting the coupling drive 13 with the driven tool 91.

The wall of the first hole 16 is formed with two first projections 162, which limit the disengagement of the steel ball 30 from the main bar 10.

In this embodiment, a spherical body is selected as the operating member 50, the detent lever 20 is formed diagonally to a driven surface 23 at one end away from the first end 11, and the operating member 50 abuts against the driven surface 23, whereby when the operating member 50 is pressed to move toward the interior of the main bar 10, the operating member 50 presses against the diagonally oriented driven surface 23 to force the detent lever 20 to be axially displaced in a direction toward the first end 11, and in cooperation with the selection of the spherical body as the operating member 50, the wall of the second hole 17 is formed into a circular second projection 172 which limits the operating member 50 from being disengaged from the main bar 10.

The operation of positioning the steel ball 30 and the operating member 50 in the first hole 16 and the second hole 17, respectively, is an established technique familiar to those skilled in the art of the present invention and is not necessarily related to the technical means of the present invention so that the installation process of the steel ball 30 and the operating member 50 will not be discussed in detail.

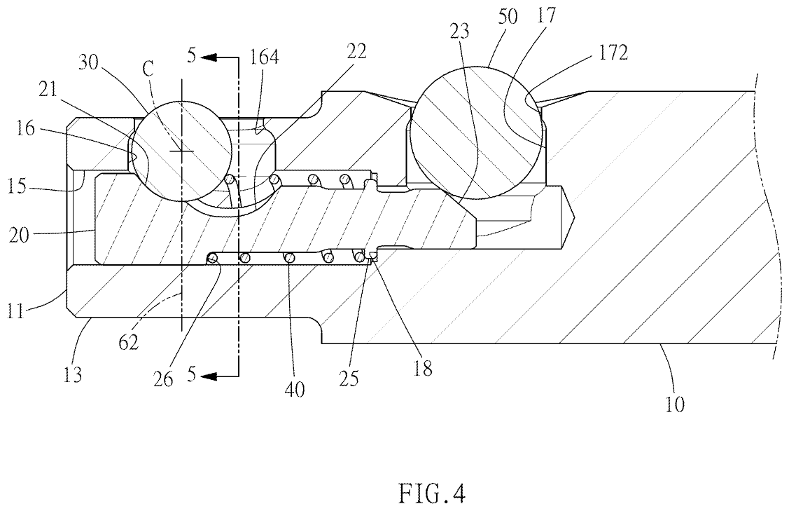

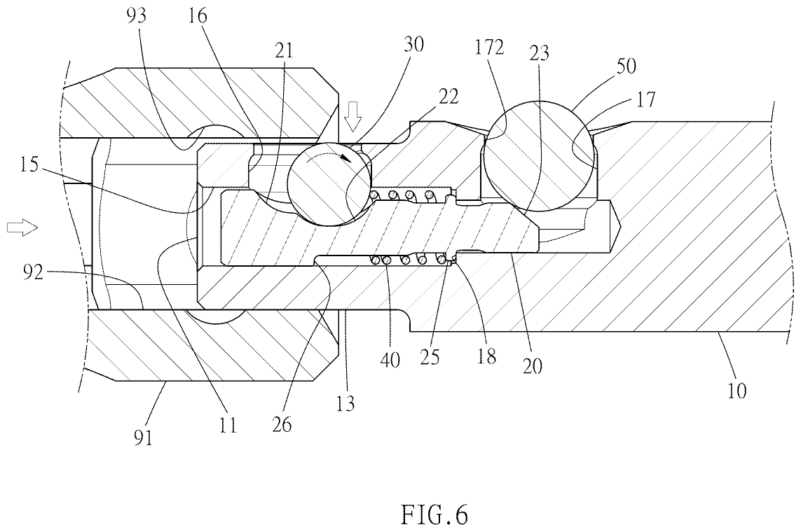

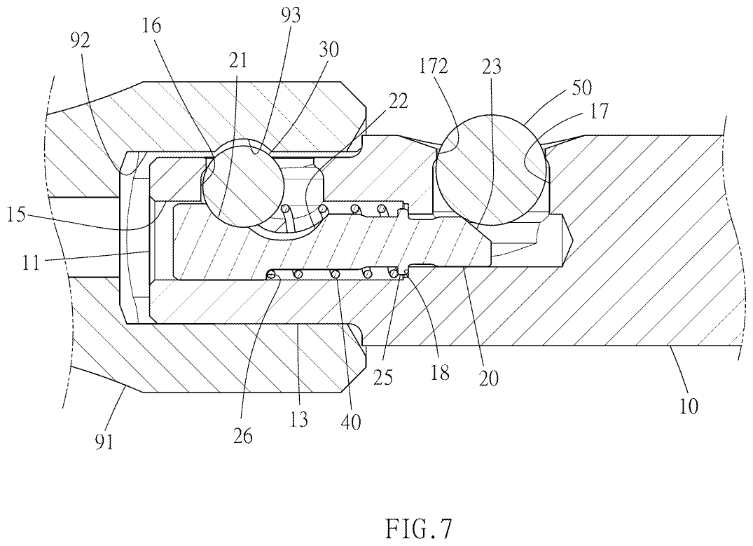

As shown in FIG. 6, when the coupling drive 13 is relatively inserted into the drive hole 92, one end portion 94 of the driven tool 91 forms a lateral thrust on the portion of the steel ball 30 protruding from the main bar 10, so there is no need to press and operate the operating member 50. While the detent lever 20 maintains the positioning state as shown in FIG. 4, by utilizing the relative formation of the first hole 16 and the steel ball 30, the driven tool 91 can force the steel ball 30 to roll and embed itself in the second groove 22 in the direction away from the first end 11, and the steel ball 30 elastically compresses and deforms against the spring 40 so that the coupling drive 13 can further penetrate the drive hole 92. As shown in FIG. 7, when the recess 93 and the first hole 16 are opposed to each other, the spring 40 provides a spring force to cause the steel ball 30 to move toward the first end 11 and to be embedded back into the first groove 21, the portion of the steel ball 30 again protrudes from the outside of the main bar 10 and is embedded in the recess 93, and the portion of the detent lever 20 located in the first groove 21 forcing the steel ball 30 to be unable to come out of the recess 93 and the coupling drive 13 to be unable to be disengaged from the drive hole 92 in the reverse direction, thereby completing the connection of the coupling drive 13 to the driven tool 91.

When the operating member 50 is pressed and operated, the operating member 50 forces the detent lever 20 to be displaced toward the first end 11 direction where the second groove 22 faces the steel ball 30, so that the steel ball 30 can be embedded in the second groove 22 and come out of the recess 93, and the coupling drive 13 can be disengaged from the drive hole 92, causing the coupling drive 13 and the driven tool 91 to be disengaged.

Therefore, there is no need to press and operate the operating member 50, then the coupling drive 13 and the driven tool 91 can be connected and positioned, and the connection of the coupling drive 13 and the driven tool 91 can be conveniently operated.

After the coupling drive, 13 is inserted into the driven tool 91, since one end of the spring 40 exerts a pushing force on the steel ball 30 if the user or an external foreign object accidentally touches the operating member 50 without simultaneously operating the driven tool 91 and the coupling drive 13 to move in the reverse direction, the steel ball 30 cannot be moved from the first groove 21 to the second groove 22 and will remain embedded in the recess 93 so that the coupling relationship between the driven tool 91 and the coupling drive 13 can be maintained.

A virtual centerline 62 is defined to pass through the spherical center C of the steel ball 30, the centerline 62 extending through the first groove 21 and being orthogonal to the first groove 21, whereby compression on the steel ball 30 along the radial direction of the main bar 10 would not force the steel ball 30 to roll from the first groove 21 into the second groove 22.

Wherein, the first groove 21 and the second groove 22 are spherical arc-shaped grooves cooperating with the steel ball 30, whereby when the steel ball 30 or the detent lever 20 is operated, the detent lever 20 will be relatively constrained by the steel ball 30 and cannot be rotated.

The main bar 10 forms a spherical arc surface 164 which cooperates with the shape of the steel ball 30, and the spherical arc surface 164 is located in the direction of the first hole 16 away from the first end 11, and when the steel ball 30 is rolled from the first groove 21 to be embedded in the second groove 22, a portion of the steel ball 30 is laterally abutted against the spherical arc surface 164, which enhances the smoothness of the action of the steel ball 30 entering the second groove 22.

The detent lever 20 radially expands an annular flange 25 located between the second groove 22 and the operating member 50, with one end of the spring 40 pressing against the annular flange 25.

In conjunction with the formation of the annular flange 25, the main bar 10 is radially formed with a stop portion 18 located within the chamber 15, and the annular flange 25 is located between the spring 40 and the stop portion 18 so that the stop portion 18 provides a stop effect for the annular flange 25, thereby limiting the displacement of the detent lever 20 in a direction away from the first end 11.

The detent lever 20 is radially formed with a limiting surface 26 which is located between the annular flange 25 and the first end 11, and which limits one end of the spring 40 in the direction close to the first end 11. Accordingly, when the spring 40 is elastically compressed by the movement of the steel ball 30 or the detent lever 20, the end of the spring 40 in the direction close to the first end 11 presses against the steel ball 30 and the limiting surface 26, thereby preventing the spring 40 from being biased against the force, and the spring 40 can be held in its axial direction and not easily bent, thereby preventing the wire loop of the spring 40 from relatively clamping the steel ball 30. Wherein the limiting surface 26 and the steel ball 30 opposing each other radially along the main bar 10 is a preferred embodiment.

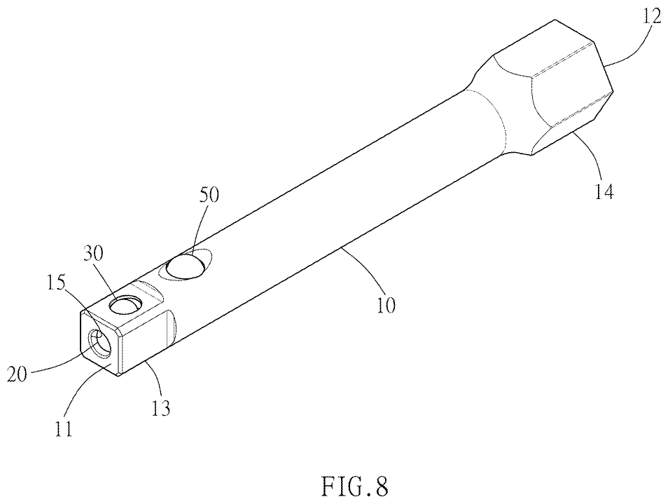

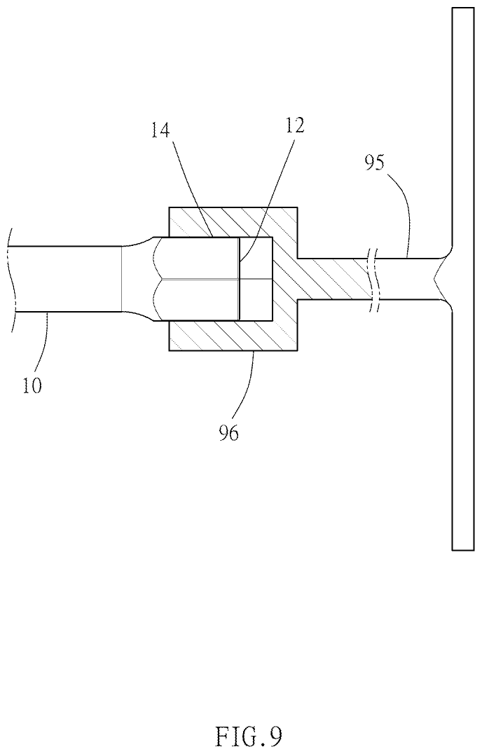

As shown in FIGS. 8 and 9, which show an Embodiment 2 used to connect another operating tool 95 which is a T-handle wrench with a cylindrical socket structure 96. The Embodiment 2 differs from the Embodiment 1 in that the connection portion 14 is a polygonal columnar structure used to cooperatively fit into the socket structure 96.

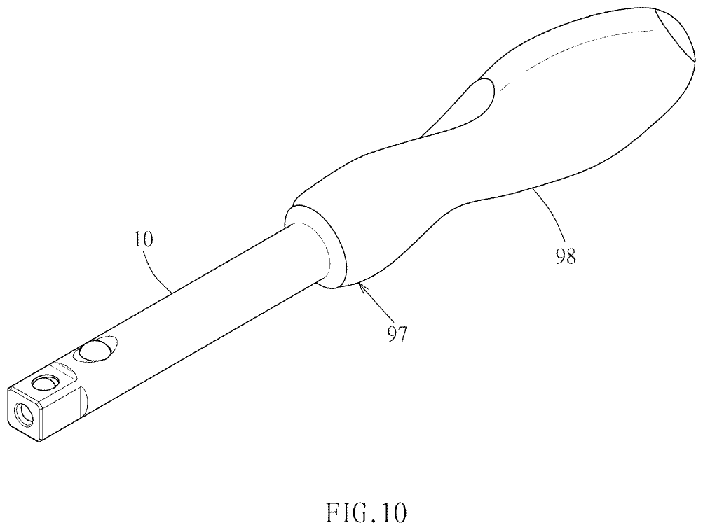

As shown in FIG. 10, which shows an Embodiment 3 of an operating tool 97, namely a screwdriver, the operating tool 97 comprises a main bar 10 and a handle 98, wherein the main bar 10 is axially inserted into the handle 98.

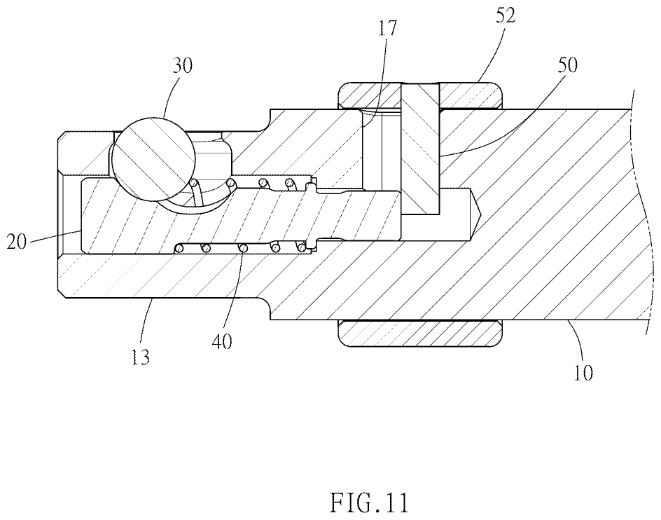

As shown in FIG. 11, which shows an Embodiment 4 differing from the Embodiment 1 in that the second hole 17 is an elongated hole formed along the axial direction of the main bar 10. The operating member 50 is a rod with a length, one side of the operating member 50 abuts against the one end of the detent lever 20 in the direction away from the first end 11, and the operating member 50 is connected to a sliding sleeve 52 protruding from the main bar 10, whereby operation of the sliding sleeve 52 along the axial direction of the main bar 10 can cause the operating member 50 to force the detent lever 20 to be displaced toward the first end 11 direction.

I claim:

1. An operation-free connection structure, which is used to connect a driven tool having a polygonal drive hole in which a recessed recess is formed on a wall within the drive hole; the connection structure comprising:
an elongated main bar, one axial end of the main bar being defined as a first end, a coupling drive being provided on the main bar in conjunction with the drive hole extending to the first end such that the coupling drive is axially inserted into the drive hole to rotate the driven tool; the main bar is axially formed with an elongated chamber therein extending to the first end, and the main bar is axially formed with a first hole and a second hole both connected to the chamber and to a radial periphery of the main bar, respectively, the first hole being located between the second hole and the first end, the first hole being formed in the coupling drive;
a detent lever provided in the chamber, the radial periphery of the detent lever is recessed with a first groove and a second groove, the depth of the first groove is smaller than the depth of the second groove along the radial direction of the detent lever; the first groove is located between the first end and the second groove, and the first groove and the second groove are configured along the axial direction of the detent lever;
a steel ball is disposed in the first hole;
a spring, wherein the detent lever axially threads the spring, both ends of the spring press against the detent lever and the steel ball, respectively, so that a portion of the steel ball is embedded in the first groove and the other portion thereof protrudes outwardly from the radial surface of the main bar; and
an operating member is provided in the second hole, wherein a portion of the operating member protrudes radially outwardly from the main bar and another portion thereof enters into the inner portion of the main bar and abuts against the detent lever, thereby enabling the operating member to force the detent lever to be axially displaced toward the first end;
wherein, the first hole is an elongated hole, the length of the first hole along the axial direction of the main bar is greater than the width of the first hole along the lateral direction of the coupling drive, and the width of the first hole along the lateral direction of the coupling drive is smaller than the outer diameter of the steel ball, which allows the steel ball to be compressed by the driven tool to roll and embed in the second groove, thereby facilitating the free operation of the operating member to accomplish the operation of connecting the coupling drive with the driven tool.

2. The operation-free connection structure according to claim 1, wherein, a virtual centerline is defined to pass through the spherical center of the steel ball, the centerline extending through the first groove and being orthogonal to the first groove.

3. The operation-free connection structure according to claim 2, wherein, the first groove and the second groove are spherical arc-shaped grooves cooperating with the steel ball.

4. The operation-free connection structure according to claim 1, wherein, the main bar forms a spherical arc surface which cooperates with the shape of the steel ball, and the spherical arc surface is located in the direction of the first hole away from the first end.

5. The operation-free connection structure according to claim 1, wherein, the detent lever radially expands an annular flange located between the second groove and the operating member, with one end of the spring pressing against the annular flange.

6. The operation-free connection structure according to claim 5, wherein, the main bar is radially formed with a stop portion located within the chamber, and the annular flange is located between the spring and the stop portion so that the stop portion provides a stop effect for the annular flange, thereby limiting the displacement of the detent lever in a direction away from the first end.

7. The operation-free connection structure according to claim 5, wherein, the detent lever is radially formed with a limiting surface which is located between the annular flange and the first end to limit one end of the spring in the direction close to the first end.

8. The operation-free connection structure according to claim 1, wherein, the detent lever is formed diagonally to a driven surface at one end away from the first end, and the operating member abuts against the driven surface.

9. The operation-free connection structure according to claim 1, wherein, the second hole is an elongated hole formed along the axial direction of the main bar; the operating member is a rod with a length, one side of the operating member abuts against the one end of the detent lever in the direction away from the first end, and the operating member is connected to a sliding sleeve protruding from the main bar.
